(19) United States
(12) Patent Application Publication
(10) Pub. No.: US 2026/0246090 A1
(43) Pub. Date: Aug. 20, 2026

(54) SEPARATOR FOR LITHIUM SECONDARY BATTERY, METHOD FOR MANUFACTURING SAME, AND LITHIUM SECONDARY BATTERY COMPRISING THE SAME

(71) Applicants: Hyundai Motor Company, Seoul (KR); Kia Corporation, Seoul (KR); UIF (University Industry Foundation), Yonsei University, Seoul (KR)

(72) Inventors: Junki Rhee, Hwaseong (KR); Youngjoon Roh, Hwaseong (KR); Seungyeop Choi, Seoul (KR); Yong Min Lee, Seoul (KR); Jun Pyo Seo, Seoul (KR)

(21) Appl. No.: 19/235,021

(22) Filed: Jun. 11, 2025

(30) Foreign Application Priority Data
Feb. 20, 2025 (KR) 10-2025-0022182

(51) Int. Cl. H01M 50/446; H01M 50/417; H01M 50/42; H01M 50/434; H01M 50/443; H01M 50/449; H01M 50/489; H01M 50/491

(52) U.S. Cl. CPC H01M 50/446; H01M 50/417; H01M 50/42; H01M 50/434; H01M 50/443; H01M 50/449; H01M 50/489; H01M 50/491

(57) ABSTRACT

Provided is a separator for lithium secondary batteries. The separator features a porous substrate coated with hydrophilic ceramic particles and a binder. The ceramic particles may be aluminum nitride modified with silicic or phosphoric acid, while the binder can include polyacrylic acid, carboxymethyl cellulose, polyvinyl alcohol, styrene-butadiene rubber, polyethylene oxide, or combinations thereof. The mass ratio between ceramic particles and binder is about 80:20 to 99:1. The substrate has a thickness of about 3 to 30 micrometers and a porosity of about 30% to 80%. A simple water-based method involves surface modification of the ceramic particle, preparation of a slurry with the binder, and coating of the porous substrate, followed by vacuum drying at 40° C. to 80° C.

### CROSS-REFERENCE TO RELATED APPLICATION

This present application claims the benefit of priority to Korean Patent Application No. 10-2025-0022182, filed on Feb. 20, 2025, in the Korean Intellectual Property Office, the entire disclosure of which is incorporated herein by reference.

### BACKGROUND

### Technical Field

The present disclosure relates to a separator for a lithium secondary battery having improved heat resistance and electrolyte affinity, a method for manufacturing same, and a lithium secondary battery comprising the same.

### Background

Recently, as lithium secondary batteries are being increasingly applied in various fields such as electric vehicles (HEVs, EVs) and energy storage systems (ESS), there is an increasing demand for high output, high energy density, and high safety. To meet these demands, continuous improvements are being made to the performance of each component of lithium secondary batteries, including positive electrodes, negative electrodes, separators, and electrolytes. Separators, in particular, play an important role as a pathway for lithium ion movement and help prevent internal short circuits by blocking direct contact between the positive and negative electrodes.

However, polyolefin porous substrate separators, which are currently in wide use, are prone to thermal shrinkage in high-temperature environments due to their low heat resistance. This increases the possibility of causing internal short circuits as the separator shrinks, which ultimately may cause a reduction in battery safety. In addition, polyolefin-based separators have low thermal conductivity, which may prevent effective dissipation of heat generated inside the battery during internal short circuits, overcharging, or high-speed charging and discharging. These issues may lead to excessive heat accumulating locally, promoting thermal shrinkage of the separator and further threatening battery stability.

Furthermore, polyolefin-based separators exhibit low wettability due to their hydrophobic surface, resulting in poor affinity with electrolytes. This can result in longer times for electrolyte impregnation into the separator and reduced efficiency in battery manufacturing processes. To address these issues, technologies such as coating thermally conductive fillers on the separator surface have been researched. Thermally conductive fillers can help dissipate heat generated inside the battery to the outside through the separator. However, even when such fillers are used, it remains difficult to apply aqueous coating processes due to the low moisture stability of the fillers.

Accordingly, efforts continue to be made to improve separator performance and stability by introducing appropriate fillers or coating layers to increase affinity with electrolytes while simultaneously ensuring thermal conductivity and heat resistance.

### SUMMARY

The present disclosure is directed to providing a separator for a lithium secondary battery with improved heat resistance and electrolyte affinity by introducing a coating layer comprising surface-modified ceramic particles on a porous substrate for a lithium secondary battery separator, a method for manufacturing same, and a lithium secondary battery comprising the same.

A separator for a lithium secondary battery according to an embodiment of the present disclosure may comprise a porous substrate and a coating layer disposed on at least one surface of the porous substrate.

The coating layer may comprise hydrophilic ceramic particles and a binder.

A lithium secondary battery according to an embodiment of the present disclosure may comprise a separator for a lithium secondary battery according to various embodiments of the present disclosure.

A method for manufacturing a separator for a lithium secondary battery according to an embodiment of the present disclosure may comprise modifying a surface of ceramic particles to prepare a surface-modified hydrophilic ceramic particles, preparing a slurry by mixing the surface-modified hydrophilic ceramic particles, a binder, and a solvent, and coating the slurry on at least one surface of a porous substrate.

The separator for a lithium secondary battery according to the present disclosure may have improved affinity with electrolytes by comprising a coating layer comprising hydrophilic ceramic particles.

Accordingly, side reactions with electrolytes may be prevented and wettability of the separator may be improved.

In addition, the ionic conductivity of the separator may be improved, and improved moisture stability may be secured.

The separator for a lithium secondary battery according to the present disclosure may have improved moisture stability, thus allowing the application of aqueous coating processes. Accordingly, the separator may be environmentally friendly, economical, and have improved productivity.

The separator for a lithium secondary battery according to the present disclosure comprises surface-modified ceramic particles and may thus reduce binder content in a coating layer while securing adhesion characteristics of the coating layer.

As discussed, the method and system suitably include use of a controller or processer.

In another embodiment, vehicles are provided that comprise an apparatus as disclosed herein.

### BRIEF DESCRIPTION OF THE DRAWINGS

The foregoing and other aspects, features, and advantages, as well as the following detailed description of the embodiments, will be better understood when read in conjunction with the accompanying drawings. However, the present disclosure is not intended to be limited to the details shown in the drawings, and various modifications and structural changes may be made therein without departing from the spirit of the present disclosure and within the scope and range of equivalents of the claims. Like reference numbers and designations in the various drawings indicate like elements.

FIG. 1 is a schematic diagram briefly illustrating a process of hydrophilically treating the surface of ceramic particles according to some embodiments of the present disclosure.

FIG. 2A shows a SEM image of the surface of separator prepared in Example 1.

FIG. 2B shows a SEM image of the surface of separators prepared in Comparative Example 1.

FIG. 2C shows a SEM image of the surface of separators prepared in Comparative Example 2.

FIG. 3A shows an image of the surface contact angle of a separator prepared in Example 1.

FIG. 3B shows an image of the surface contact angle of a separator prepared in Comparative Example 1.

FIG. 3C shows an image of the surface contact angle of a separator prepared in Comparative Example 2.

FIG. 4 is a graph showing the adhesion characteristics of separators according to Experimental Example 3.

FIG. 5 shows images of the separators before and after thermal shrinkage according to Experimental Example 4.

FIG. 6 is a graph showing the capacity characteristics of batteries according to Experimental Example 5.

FIG. 7 is a graph showing the rate characteristics of batteries according to Experimental Example 5.

### DETAILED DESCRIPTION

Unless otherwise defined, all terms (including technical and scientific terms) used herein as is customary in the art to which the inventive concept of the present disclosure belongs. It will be understood that terms in common usage should also be interpreted as is customary in the relevant art and not in an idealized or overly formal sense unless expressly so defined herein.

The term “hydrophilic ceramic particles” herein refers to ceramic particles capable of exhibiting water-affinity, such as through a contact angle below about 90 degrees.

The term “surface-modified ceramic particles” herein refers to ceramic particles whose surfaces have been treated (chemically or physically) to alter properties.

The term “mass ratio” herein refers to the ratio (by weight) of two or more components in a mixture, expressed as, for example, “A:B” or a percentage of each component relative to the total mixture mass.

The term “porosity” herein refers to the volumetric or area-based fraction of void space in a substrate.

The term “average particle diameter” herein refers to the mean diameter of a population of particles, as measured by a standardized technique such as laser diffraction or scanning electron microscopy image analysis.

It will be understood that, although the terms “first,” “second,” and other numerical terms may be used herein to describe various elements, these elements should not be limited by these terms. These terms are only used to distinguish one element from another. For example, a first element could be termed a second element, and, similarly, a second element could be termed a first element, without departing from the scope of the present disclosure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. As used herein, the term “and/or” includes any and all combinations of one or more of the associated listed items. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The terminology used herein is used for the purpose of describing particular exemplary embodiments only and is not intended to be limiting. As used herein, the articles “a,” “an,” and “the,” include plural referents unless the context clearly dictates otherwise. In the following disclosure, the terms “include,” “comprise,” “have,” and the like designate the existence of features, steps, elements, and combinations thereof, but should not be understood as precluding the existence or addition of one or more other features, steps, elements, and combinations thereof. A method for manufacturing a separator for a lithium secondary battery according to an embodiment of the present disclosure may comprise modifying a surface of ceramic particles, preparing a slurry by mixing the surface-modified ceramic particles, a binder, and a solvent, and coating the slurry on at least one surface of a porous substrate.

A method for manufacturing a separator for a lithium secondary battery according to an embodiment of the present disclosure may comprise modifying a surface of ceramic particles, preparing a slurry by mixing the surface-modified ceramic particles, a binder, and a solvent, and coating the slurry on at least one surface of a porous substrate.

According to an embodiment of the present disclosure, in the modifying the surface of the ceramic particles, the surface of aluminum nitride (AlN) may be modified with silicic acid or phosphoric acid.

Aluminum nitride is a solid nitride of aluminum, that is, a ceramic material, with excellent thermal conductivity, and can thus efficiently transfer or discharge heat inside the battery when incorporated into a separator for a lithium secondary battery.

In the present disclosure, surface modification may mean chemically reacting the ceramic particles with silicic acid or phosphoric acid to coat the surface of the ceramic particles such that it has hydrophilicity.

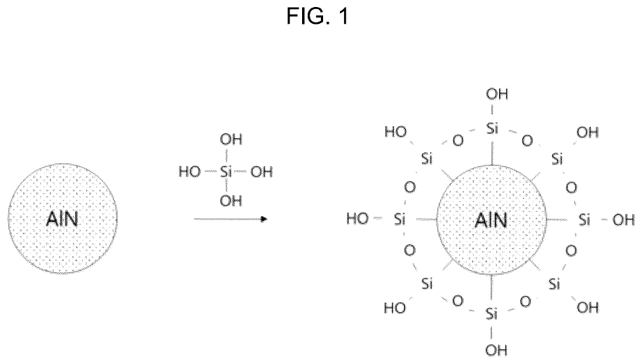

A process of modifying the surface of aluminum nitride with silicic acid according to an embodiment is shown in FIG. 1.

Referring to FIG. 1, the aluminum nitride may have its surface modified with numerous —OH functional groups positioned at the outermost part, giving it hydrophilicity. Accordingly, electrolyte wettability and ion conduction characteristics of the separator for a lithium secondary battery according to the present disclosure may be improved.

According to an embodiment, the ceramic particles may have an average particle diameter of 0.8 to 3.0 μm. Preferably, the ceramic particles may have an average particle diameter of 1.2 to 1.8 μm.

When the average particle diameter of the ceramic particles is less than 0.8 μm, they may block the pores of the porous substrate (described below), thereby reducing the ionic conductivity.

When the average particle diameter of the ceramic particles exceeds 3.0 μm, they may cause the surface to be non-uniform in the coating layer (described below), thereby reducing the mechanical stability of the separator.

Accordingly, the range indicated above may be preferable.

In the preparing the slurry according to the present disclosure, the surface-modified ceramic particles, a binder, and a solvent may be mixed.

The binder may include one or more of polyacrylic acid (PAA), carboxymethyl cellulose (CMC), polyvinyl alcohol (PVA), styrene-butadiene rubber (SBR), polyethylene oxide (PEO) and any combination thereof.

The solvent may be water. The separator for a lithium secondary battery manufactured according to the method for manufacturing a separator for a lithium secondary battery of the present disclosure includes surface-modified ceramic particles and may thus have improved moisture stability. Accordingly, an aqueous coating process using water as a solvent may be applied. When a coating layer is formed through an aqueous coating process, it may be environmentally friendly, economical, and have improved productivity.

According to an embodiment, the surface-modified ceramic particles and the binder may be mixed in a mass ratio of 80:20 to 99:1. Preferably, the surface-modified ceramic particles and the binder may be mixed in a mass ratio of 95:5 to 99:1.

The separator for a lithium secondary battery manufactured according to the method for manufacturing a separator for a lithium secondary battery of the present disclosure comprises surface-modified ceramic particles, and thus, compared to existing separators for lithium secondary batteries, adhesive properties of the coating layer may be secured even with a minimal binder content.

According to an embodiment, in the preparing a slurry, the slurry may be prepared such that a sum of the masses of the surface-modified ceramic particles and the binder is 20 to 40% of the total mass of the slurry. That is, the slurry of the present disclosure may have a ratio of the sum of the masses of the surface-modified ceramic particles and the binder to the mass of the solvent of 20:80 to 40:60. Preferably, the ratio may be 25:75 to 35:65.

In the coating the slurry of the present disclosure, the slurry may be coated on at least one surface of the porous substrate. That is, in one example, the slurry may be coated on one surface of the porous substrate. In another example, the slurry may be coated on both surfaces of the porous substrate.

The coating may be carried out through commercially available coating processes such as bar coating, slot die coating, doctor blade coating, dip coating, spray coating, and the like.

The porous substrate may include one or more of a polyolefin-based resin, a fluorine-based resin, a polyester-based resin and any combination thereof, wherein the polyolefin-based resin includes polyethylene (PE) or polypropylene (PP), and wherein the fluorine-based resin includes polyvinylidene fluoride (PVDF) or polytetrafluoroethylene (PTFE).

According to an embodiment, the porous substrate may have a thickness of 3 to 30 μm. Preferably, the porous substrate may have a thickness of 5 to 10 μm.

When the thickness of the porous substrate is less than 3 μm, the substrate may be too thin to secure mechanical strength, and the heat resistance of the separator may be reduced.

When the thickness of the porous substrate exceeds 30 μm, the ionic conductivity may be reduced, and the volume and weight of the entire separator or the entire lithium secondary battery may increase, lowering energy density.

Accordingly, the range indicated above may be preferable.

In addition, the porosity of the porous substrate may be 30 to 80%.

When the porosity of the porous substrate is less than 30%, the internal resistance of the lithium secondary battery may increase.

When the porosity of the porous substrate exceeds 80%, it may be difficult to maintain the mechanical properties of the substrate.

Accordingly, the range indicated above may be preferable

The coating the slurry may further comprise drying or curing the coated slurry after coating the slurry as described above. At this time, the slurry may be dried under vacuum at 40 to 80° C. for 10 to 14 hours.

The separator for a lithium secondary battery according to the present disclosure may be manufactured through the manufacturing method as described above.

That is, the separator for a lithium secondary battery according the present disclosure may include a porous substrate, and a coating layer disposed on at least one surface of the porous substrate.

The porous substrate is the same as the porous substrate described above, so a detailed explanation thereof will be omitted.

The coating layer may include hydrophilically treated ceramic particles and a binder.

The ceramic particles are the same as those described above and may be hydrophilically treated by modifying the surface of aluminum nitride (AlN) with silicic acid or phosphoric acid.

The binder is also the same as that described above, so a detailed explanation thereof will be omitted.

The ceramic particles and the binder included in the coating layer may be included in a mass ratio of 80:20 to 99:1, as described above. Preferably, ceramic particles and the binder included in the coating layer may be included in a mass ratio of 95:5 to 99:1.

The lithium secondary battery according to the present disclosure may include a positive electrode, a negative electrode, an electrolyte, and the separator for a lithium secondary battery according to various embodiments of the present disclosure.

The positive electrode may use one or a mixture of two or more lithium-containing transition metal oxides commonly used in lithium secondary batteries but is not limited thereto. As the lithium-containing transition metal oxide, for example, complex oxides of lithium with cobalt, nickel, manganese, or the like may be used.

The negative electrode may include carbon-based materials commonly used in lithium secondary batteries but is not limited thereto.

The electrolyte may include a lithium salt, a solvent, and other additives, but is not limited to any specific type, and any commercially available electrolyte may be used.

The lithium secondary battery according to the present disclosure may have improved capacity retention and high-rate characteristics by including the separator for a lithium secondary battery according to various embodiments described above.

Hereinafter, the present disclosure will be described in more detail by means of examples. However, the following examples and experimental examples are provided merely to describe the present disclosure in more detail, and the scope of the present disclosure is not limited by the following examples and experimental examples.

### Example 1

First, for the surface modification of ceramic particles included in the coating layer, aluminum nitride with a particle diameter of 1.4 μm, silicic acid, and ethanol were mixed and stirred for 2 hours. Thereafter, the aluminum nitride was filtered, and excess silicic acid was washed with ethanol to hydrophilically treat the surface of the aluminum nitride. A slurry was prepared by mixing this surface-modified aluminum nitride with polyacrylic acid and water (DI water). Here, the slurry was prepared such that the mass ratio of aluminum nitride, polyacrylic acid, and water was prepared to be 29:1:70. Subsequently, the slurry was coated on one surface of a polyethylene porous substrate with a thickness of 8.6 μm using a bar coating process. Thereafter, the coated substrate was dried in a vacuum oven at 60° C. for 12 hours to manufacture the final separator for a lithium secondary battery.

### Comparative Example 1

A porous substrate made of polyethylene with a thickness of 8.6 μm without a coating layer was prepared as a separator for a lithium secondary battery.

### Comparative Example 2

A slurry was prepared by mixing aluminum nitride without surface modification with polyacrylic acid and water (DI water). The mass ratio of aluminum nitride, polyacrylic acid, and water was prepared to be 29:1:70. Subsequently, the slurry was coated on one surface of a polyethylene porous substrate with a thickness of 8.6 μm using a bar coating process. Thereafter, the coated polyethylene porous substrate was dried in a vacuum oven at 60° C. for 12 hours to manufacture the final separator for a lithium secondary battery.

### Comparative Example 3

A separator for a lithium secondary battery was manufactured in the same manner as Comparative Example 2, except that the mass ratio of aluminum nitride, polyacrylic acid, and water was 28.5:1.5:70.

### Comparative Example 4

A separator for a lithium secondary battery was manufactured in the same manner as Comparative Example 2, except that the mass ratio of aluminum nitride, polyacrylic acid, and water was 27:3:70.

### Experimental Example 1

In this experiment, the properties of the separators prepared in Example 1, Comparative Example 1, and Comparative Example 2 were analyzed.

For this purpose, coin cells with a configuration of SUS/separator/SUS were manufactured using stainless steel (Steel Use Stainless). The bulk resistance of the manufactured coin cells was measured to calculate the resistance and ionic conductivity of the separators according to the examples and comparative examples.

In addition, using a Densometer, which is an air permeability meter, the time required for 100 mL of air to pass through was measured to compare the air permeability of the separators according to the examples and comparative examples.

The results are shown in Table 1 below.

(Below, the respective coin cells are simply referred to as Example 1, Comparative Example 1, and Comparative Example 2.)

TABLE 1

| | Separator | Air | | Ionic |
|---|---|---|---|---|
| | Thickness | Permeability | Resistance | Conductivity |
| | (μm) | (sec 100 mL⁻¹) | (Ohms) | (mS cm⁻¹) |
| Example 1 | 15 | 204.5 | 1.175 | 0.635 |
| Comparative | 8.6 | 127.0 | 0.987 | 0.433 |
| Example 1 | | | | |
| Comparative | 15 | 206.2 | 1.203 | 0.620 |
| Example 2 | | | | |

Referring to Table 1, for Example 1, the separator thickness was thicker, and the resistance was somewhat higher compared to Comparative Example 1, which did not apply a separate coating layer. However, it can be seen that Example 1 had air permeability, resistance, and ionic conductivity comparable to those of Comparative Example 2, which used existing aluminum nitride without surface modification. In particular, the resistance and ionic conductivity of Example 1 showed better values compared to those of Comparative Example 2, confirming its superior performance as a lithium secondary battery separator.

### Experimental Example 2

In this experiment, the surface morphology of the separators prepared in Example 1, Comparative Example 1, and Comparative Example 2 was analyzed using an FE-SEM device.

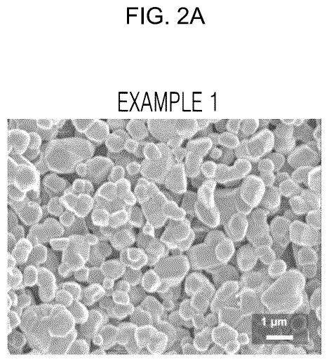

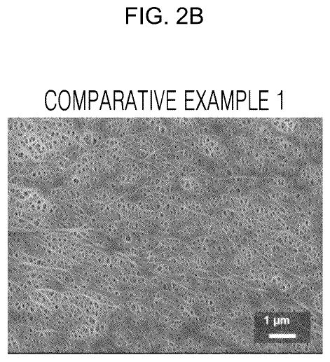

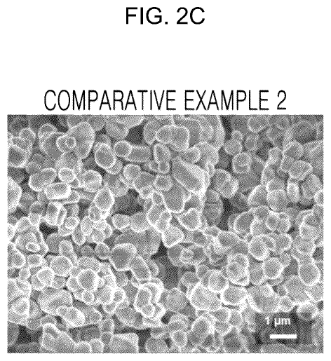

The results are shown in FIGS. 2A, 2B and 2C.

FIG. 2A shows a SEM image of the surface of separator prepared in Example 1.

FIG. 2B shows a SEM image of the surface of separators prepared in Comparative Example 1.

FIG. 2C shows a SEM image of the surface of separators prepared in Comparative Example 2.

Referring to FIG. 2A, for Example 1, it can be confirmed that the coating layer composition containing aluminum nitride is uniformly applied. On the other hand, referring to FIG. 2B for Comparative Example 1, only the polyethylene porous substrate surface is observed, as no coating layer was applied. Referring to FIG. 2C, for Comparative Example 2, a significant change in morphology can be observed compared to Example 1. It can be understood that in Comparative Example 2, unlike Example 1, agglomeration of the composition occurred due to the side reactions as shown in the following chemical reactions, as the surface of the aluminum nitride was not modified:

### Chemical Reactions:

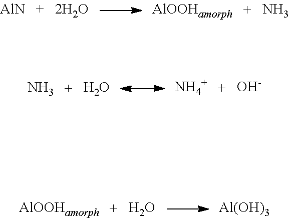

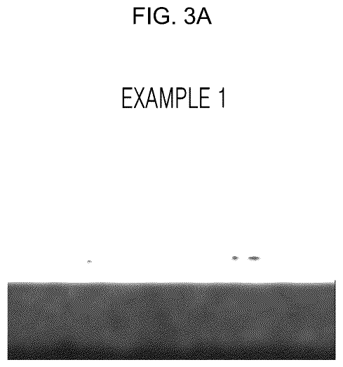

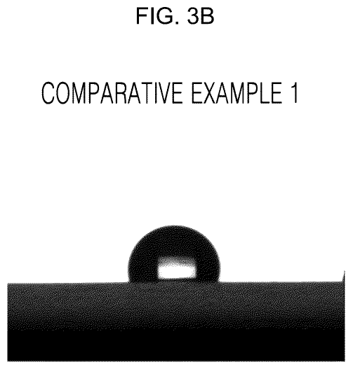

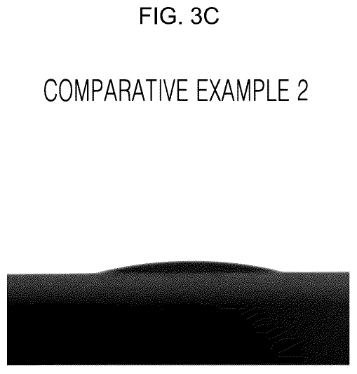

Next, the contact angles of the separators according to Example 1, Comparative Example 1, and Comparative Example 2 with water (DI water) was observed, and the images are shown in FIGS. 3A, 3B and 3C.

FIG. 3A shows an image of the surface contact angle of a separator prepared in Example 1.

FIG. 3B shows an image of the surface contact angle of a separator prepared in Comparative Example 1.

FIG. 3C shows an image of the surface contact angle of a separator prepared in Comparative Example 2.

Referring to FIG. 3B, it can be seen that Comparative Example 1 shows a very large contact angle. Referring to FIG. 3C, for Comparative Example 2, a smaller contact angle was observed compared to Comparative Example 1, which can be understood to be due to the introduction of a coating layer on one surface of the porous substrate. On the other hand, referring to FIG. 3A, for Example 1, almost no contact angle was observed on the separator. This can be understood as being due to the improvement of affinity with electrolytes and wettability of the separator because the surface of the ceramic particles included in the coating layer of Example 1 was treated to be hydrophilic.

### Experimental Example 3

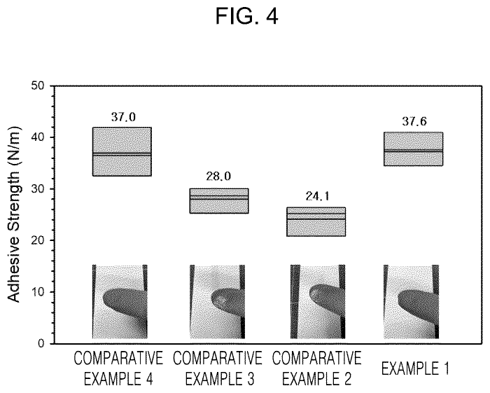

In this experiment, the adhesion characteristics of the coating layers for the separators prepared in Example 1 and Comparative Examples 2 to 4 were evaluated. The adhesion characteristics were measured using a surface and interfacial cutting analysis system (SAICAS), and the results are shown in FIG. 4.

Referring to FIG. 4, for Comparative Examples 2 and 3, the adhesive strength was 24.1 N/m and 28.0 N/m, respectively, which is significantly lower than that of Example 1. In fact, it was confirmed that the coating layer material came off upon hand contact due to the low adhesion of the coating layer. On the other hand, Example 1 showed a significantly higher level of adhesive strength compared to Comparative Examples 2 and 3 and had a similar level of adhesive strength to Comparative Example 4. Through this, it was confirmed that when a coating layer includes surface-modified ceramic particles, it can exhibit adhesion characteristics similar to those of an existing coating layer with a relatively high binder content, even with a relatively low binder content.

### Experimental Example 4

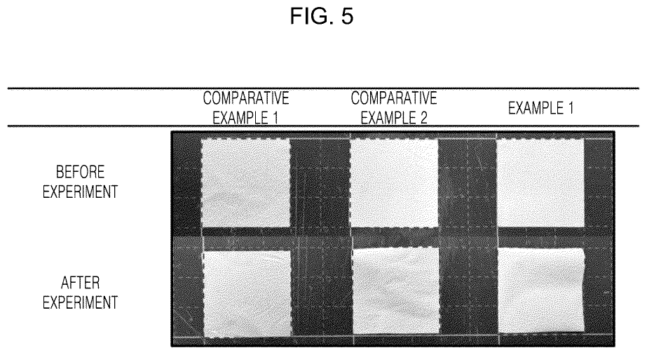

In this experiment, the thermal shrinkage rate of the separators prepared in Example 1, Comparative Example 1, and Comparative Example 2 was measured. The thermal shrinkage rate was measured by cutting each separator to the same size (30 mm×30 mm) and exposing them in an oven at 130° C. for 30 minutes. The results are shown in FIG. 5.

The thermal shrinkage rates before and after the above experiment for each separator were measured as 0% for Example 1, 8% for Comparative Example 1, and 0% for Comparative Example 2.

Through the above thermal shrinkage rate and FIG. 5, it can be seen that the separator according to Example 1 showed a lower thermal shrinkage rate compared to the separator without a coating layer and had a similar level of heat resistance (thermal shrinkage rate of 0%) to the separator with a coating layer containing existing aluminum nitride without surface modification.

### Experimental Example 5

In this experiment, the electrochemical characteristics of lithium secondary batteries manufactured using the separators prepared in Example 1, Comparative Example 1, and Comparative Example 2 were evaluated.

To manufacture lithium secondary batteries, NMC622 was used as the positive electrode, graphite was used as the negative electrode, and 1.15 M LiPF₆ in a solution of ethylene carbonate (EC) and ethyl methyl carbonate (EMC) mixed in a volume ratio of 3:7 was prepared as the electrolyte. Using the prepared lithium secondary batteries, the capacity retention rate according to cycles was observed. This experiment was measured while performing CC/CV charging at a rate of 1 C and CC discharging at a rate of 1 C for 100 cycles.

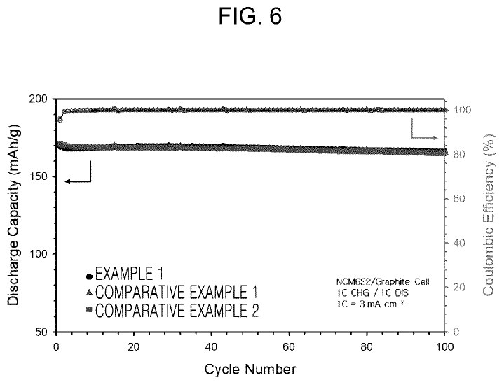

The results are shown in FIG. 6. (Below, the respective batteries are simply referred to as Example 1, Comparative Example 1, and Comparative Example 2.)

Referring to FIG. 6, it can be seen that Example 1 maintained a discharge capacity of about 170 mAh/g even as cycles were repeated. Through this, it was confirmed that Example 1 showed excellent cycle life characteristics by exhibiting a capacity retention rate equivalent to that of Comparative Examples 1 and 2 over 100 cycles. Additionally, Example 1 was measured to have a Coulombic efficiency close to 100%, confirming that it can maintain excellent reversibility even with repeated cycles.

Next, the discharge capacity at various rates was measured for Example 1 and Comparative Example 2.

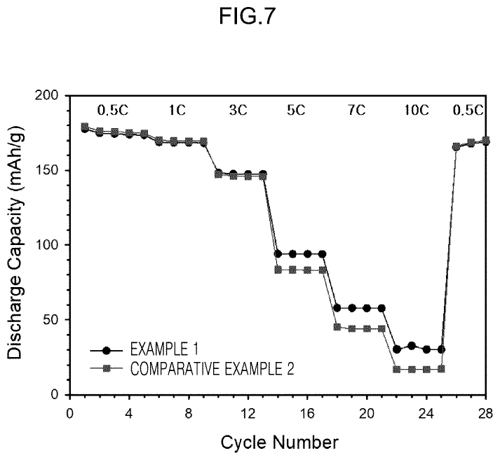

The results are shown in FIG. 7.

Referring to FIG. 7, it can be confirmed that Example 1 showed superior high-rate performance compared to Comparative Example 2. This can be understood to be due to the enhanced ionic conductivity effect obtained by treating the surface of aluminum nitride to be hydrophilic in the case of Example 1.

The present disclosure has been particularly shown and described with reference to embodiments thereof. In this regard, it will be understood by one of ordinary skill in the art that various changes in form and details may be made therein without departing from the scope of the disclosure. Therefore, the disclosed embodiments should be considered in a descriptive sense only and not in a limiting sense. The scope of the disclosure is defined not by the detailed foregoing description but by the following claims, and all differences within the scope will be construed as being included in the disclosure.

What is claimed is:

1. A separator for a lithium secondary battery, the separator comprising:
a porous substrate; and
a coating layer disposed on at least one surface of the porous substrate,
wherein the coating layer comprises hydrophilic ceramic particles and a binder.

2. The separator of claim 1, wherein the ceramic particles comprise aluminum nitride (AlN) having a surface modified with silicic acid or phosphoric acid.

3. The separator of claim 1, wherein the binder comprises one or more selected from the group consisting of polyacrylic acid (PAA), carboxymethyl cellulose (CMC), polyvinyl alcohol (PVA), styrene-butadiene rubber (SBR), polyethylene oxide (PEO) and combinations thereof.

4. The separator of claim 1, wherein the ceramic particles and the binder have a mass ratio of about 80:20 to 99:1.

5. The separator of claim 1, wherein the ceramic particles have an average particle diameter of about 0.8 to 3.0 μm.

6. The separator of claim 1, wherein the porous substrate comprises one or more selected from the group consisting of:
a polyolefin-based resin comprising polyethylene (PE) or polypropylene (PP),
a fluorine-based resin comprising polyvinylidene fluoride (PVDF) or polytetrafluoroethylene (PTFE), and
a polyester-based resin.

7. The separator of claim 1, wherein the porous substrate has a thickness of about 3 to 30 μm.

8. The separator of claim 1, wherein a porosity of the porous substrate is 30 to 80%.

9. A lithium secondary battery comprising the separator of claim 1.

10. A method for manufacturing a separator for a lithium secondary battery, the method comprising:
modifying a surface of ceramic particles to prepare a surface-modified hydrophilic ceramic particles;
preparing a slurry by mixing the hydrophilic surface-modified ceramic particles, a binder, and a solvent; and
coating the slurry on at least one surface of a porous substrate.

11. The method of claim 10, wherein the ceramic particles have an average particle diameter of 0.8 to 3.0 μm.

12. The method of claim 10, wherein the modifying a surface of ceramic particles comprises modifying a surface of aluminum nitride (AlN) with silicic acid or phosphoric acid.

13. The method of claim 10, wherein the binder comprises one or more selected from the group consisting of polyacrylic acid (PAA), carboxymethyl cellulose (CMC), polyvinyl alcohol (PVA), styrene-butadiene rubber (SBR), polyethylene oxide (PEO) and combinations thereof.

14. The method of claim 10, wherein the preparing the slurry comprises mixing the surface-modified ceramic particles and the binder in a mass ratio of about 80:20 to 99:1.

15. The method of claim 10, wherein the preparing the slurry comprises adjusting amounts so that a sum of masses of the surface-modified ceramic particles and the binder is about 20 to 40% of a total mass of the slurry.

16. The method of claim 10, wherein the solvent is water.

17. The method of claim 10, wherein the porous substrate comprises one or more selected from the group consisting of:
a polyolefin-based resin comprising polyethylene (PE) or polypropylene (PP),
a fluorine-based resin comprising polyvinylidene fluoride (PVDF) or polytetrafluoroethylene (PTFE), and
a polyester-based resin.

18. The method of claim 10, wherein the porous substrate has a thickness of about 3 to 30 μm.

19. The method of claim 10, wherein a porosity of the porous substrate is about 30 to 80%.

20. The method of claim 10, wherein the coating the slurry on at least one surface of the porous substrate comprises drying the slurry under vacuum at about 40 to 80° C. for about 10 to 14 hours.
